(19) United States
(12) Patent Application Publication
(10) Pub. No.: US 2007/0165284 A1
(43) Pub. Date: Jul. 19, 2007

(54) System and method for content based color scanning optimized enhancement using a localized approach

(75) Inventors: Hong Li, Superior, CO (US); Gerhard R. Thompson, Wappingers Falls, NY (US); Chai Wah Wu, Poughquag, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/333,567

(22) Filed: Jan. 17, 2006

(51) Int. Cl. H04N 1/409

(52) U.S. Cl. 358/3.27; 358/474

(57) ABSTRACT

A method and system of processing a document, includes analyzing a characteristic of a first pixel in a document and at least one second pixel positioned near the first pixel, classifying a value of the first pixel in accordance with the analysis, and modifying the value of the first pixel based upon the classification.

### BACKGROUND OF THE INVENTION

1. Field of the Invention

The present invention generally relates to processing of scanned documents. More particularly, the present invention relates to new and improved methods and systems for optimized enhancement of scanned documents.

2. Description of the Related Art

The pervasiveness of color scanners and printers creates an opportunity for inexpensive color copies and color e-mail. Documents to be scanned may include photographic images, graphics, and text. The data that results from a scanning process generally requires optimized enhancement to provide an output that has a high quality. Several factors determine the type of enhancement that may be required.

First, the content and quality of the original document affects the quality of the output. An original document may be old and, as a result, be dark and have lost its contrast. Therefore, an enhancement that increases the lightness/contrast may improve the scanned output from such a document.

Also, original documents may include several different types of contents of document which each may need to be processed differently. For example, an original document may have portions with text content and other portions with halftone image content. The halftone image content would benefit from being de-screened, while the text content would benefit from having text enhancement. To achieve a high quality output, content-based optimized enhancement is required.

Second, the scanning process itself will generally degrade the quality of the output image. For example, a scanner may not have a good dynamic range. Therefore, an increase in the dynamic range of the scanner may improve quality of the output.

Previous methods and systems for enhancing scanned documents perform two passes over the scanned data. The first pass involves a segmentation step that determines how to divide the document into areas (i.e. segments) based upon an analysis of the content in each segment. The content of the document is analyzed and the document is segmented based upon the content. Next, an enhancement method is assigned to each segment based upon the content in each segment.

The second pass performs the enhancement upon each individual segment in accordance with the assigned enhancement method.

### SUMMARY OF THE INVENTION

The inventors have recognized that the above methods and systems have several problems. For example, the above methods and systems all employ two passes of data to segment and process, they require a large amount of time.

For hardware-based image processors, such as copying machines, the extra, two-pass data processing may not be a substantial problem. However, the speed of the process may become crucial for software-based image processors.

Color scanners are increasingly being used within systems that have taken a modular approach to integrated systems. Most color scanners have relied upon hardware-based image processors. For example, color scanners have conventionally been incorporated into hardware “boxes,” such as color copiers and the like, which may have hardware-based processors and output devices that are incorporated into the hardware along with the color scanner. These hardware-based integrated scanners have the advantage that the processors that perform segmentation and enhancement may be incorporated into the hardware. These hardware-based processors generally have a high processing speed and, therefore, may mask the inefficiencies of the two-pass algorithm.

However, increasingly, scanners are being integrated modularly into a copier system. For example, a color scanner may be connected to a network, which in turn, may be connected to many different devices such as computers, fax machines, printers, etc. The processing of the data from the scanner is typically software-based in these modularly integrated systems. This software-based processing is much more sensitive to the efficiency of the algorithm. Therefore, the inherent inefficiencies of the two pass enhancement methods are amplified when used in the increasingly common modularly integrated systems.

Also, the segments that are generated by these methods and systems are generally fairly large and, therefore, if a misclassification happens, a large amount of data will be processed incorrectly, which may result in objectionable artifacts.

In view of the foregoing and other exemplary problems, drawbacks, and disadvantages of the above methods and systems, an exemplary feature of the present invention is to provide a method and system in which a scanned document may be analyzed, enhanced, and optimized in a single pass.

In a first exemplary aspect of the present invention, a method of processing a document, includes selecting a first pixel in a document, analyzing the characteristics of the first pixel based on at least one second pixel positioned near the first pixel, classifying a value of the first pixel in accordance with the analysis, and modifying the value of the first pixel based upon the classification.

In an exemplary embodiment of the present invention, statistical data is collected within a moving window that encloses pixels that are positioned close to a pixel (first pixel) that is to be enhanced. The first pixel may be, for example, positioned at the center of the window. The data is analyzed based upon input parameters and the scanned data at the center of the window (first pixel) is classified into one of a plurality of content types. The scanned data at the center of the window is then enhanced and processed in accordance with the classification.

In another exemplary embodiment of the present invention, new techniques are applied during the data analysis and enhancement processing which results in superior output quality.

Further, in an exemplary embodiment of the present invention, the processing of the document may be performed in one pass, which greatly increases the speed and efficiency of the processing. In comparison to the conventional two pass methods and systems, this exemplary embodiment of the present invention is faster and more accurate since any potential misclassification of the content only affects a very small portion of the output document.

These and many other advantages may be achieved with the present invention.

### BRIEF DESCRIPTION OF THE DRAWINGS

The foregoing and other exemplary purposes, aspects and advantages will be better understood from the following detailed description of exemplary embodiments of the invention with reference to the drawings, in which:

FIG. 1 illustrates an exemplary document enhancement system 100 in accordance with the present invention;

FIG. 2 illustrates a signal bearing medium 200 (e.g., storage medium) for storing steps of a program of a method in accordance with an exemplary embodiment of the present invention;

FIGS. 3A and 3B illustrate a flowchart 300 for a control routine in accordance with an exemplary embodiment of the present invention;

FIG. 4 illustrates a flowchart 400 for a text/line art enhancing control routine in accordance with an exemplary embodiment of the present invention;

FIG. 5 illustrates exemplary image windows 502 and 504 in accordance with an exemplary embodiment of the present invention; and

FIG. 6 illustrates an exemplary embodiment 600 of a system for optimized document enhancement in accordance with the present invention.

### DETAILED DESCRIPTION OF EXEMPLARY EMBODIMENTS OF THE INVENTION

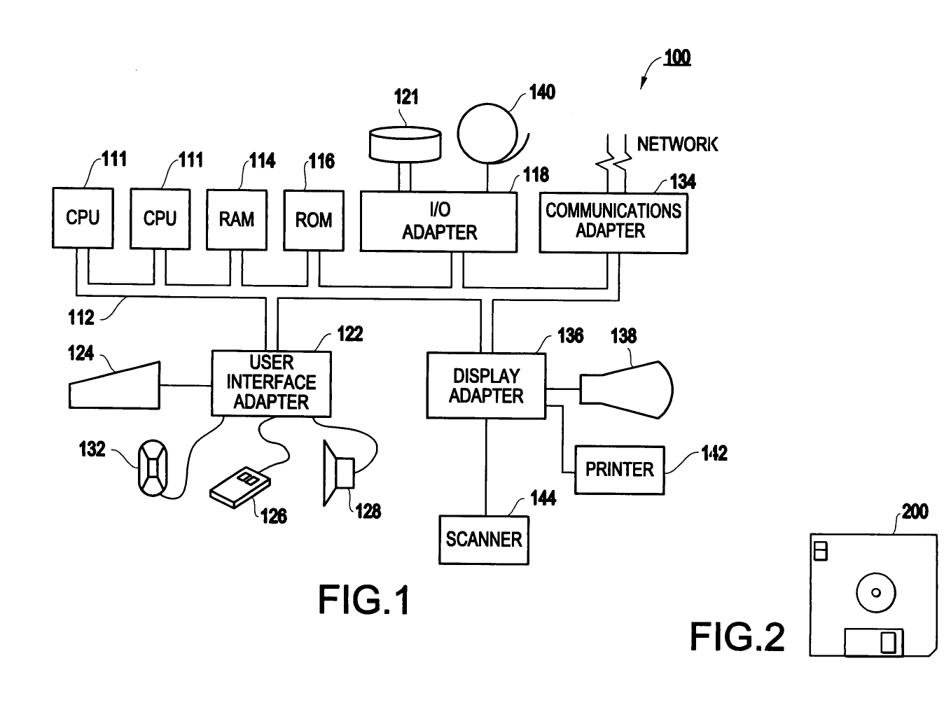

Referring now to the drawings, and more particularly to FIGS. 1-6, there are shown exemplary embodiments of the method and structures of the present invention.

FIG. 1 illustrates a typical hardware configuration of a document enhancement system 100 in accordance with an exemplary embodiment of the invention and which preferably has at least one processor or central processing unit (CPU) 111.

The CPUs 111 are interconnected via a system bus 112 to a random access memory (RAM) 114, read-only memory (ROM) 116, input/output (I/O) adapter 118 (for connecting peripheral devices such as disk units 121 and tape drives 140 to the bus 112), user interface adapter 122 (for connecting a keyboard 124, mouse 126, speaker 128, microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138, printer, 140, and/or scanner 144.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 111, as represented by the fast-access storage for example. Alternatively, the instructions may be contained in another signal-bearing media, such as a magnetic data storage diskette 200 (FIG. 2), directly or indirectly accessible by the CPU 111.

Whether contained in the diskette 200, the computer/CPU 111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

For the purposes of the following description, a low pixel value corresponds to a “dark” pixel and a high pixel value corresponds to a “light” pixel. While the following description follows this convention, one of ordinary skill in the art understands that other conventions may be used and still practice the invention.

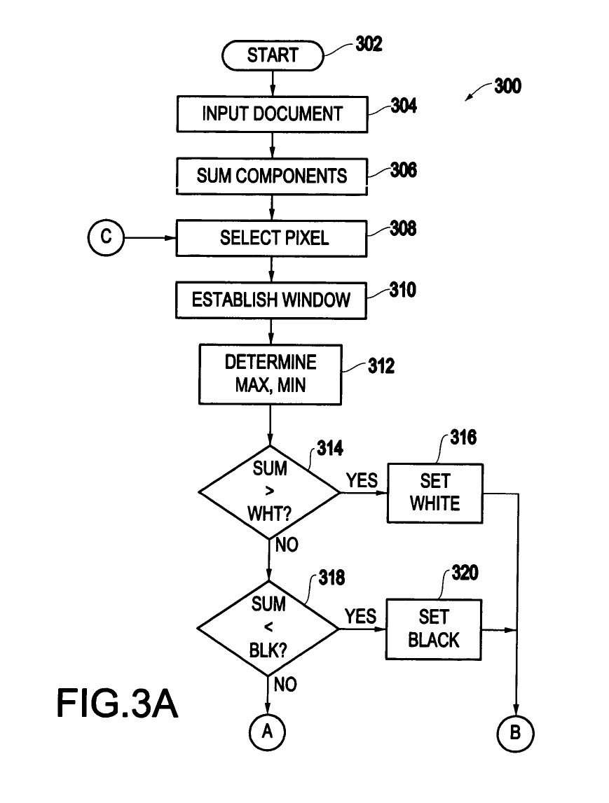

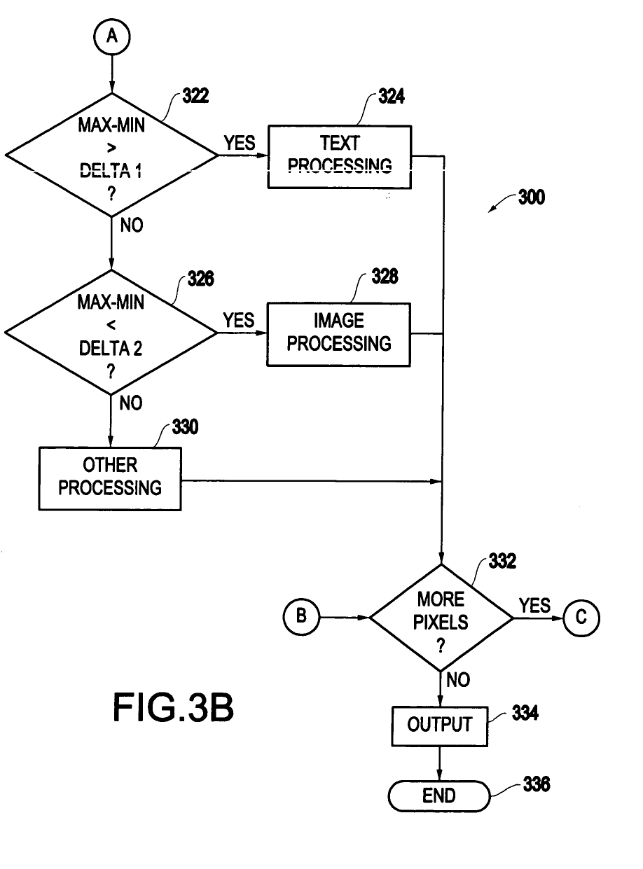

FIGS. 3A and 3B illustrate a flowchart 300 for a control routine in accordance with an exemplary embodiment of a document enhancement method in accordance with the present invention. The control routine starts at step 302 and continues to step 304. At step 304, the control routine receives the input document from, for example, a color scanner, or the like.

The control routine continues to step 306 where the color component values for each pixel in the input document are aggregated. An example of an aggregation operation is a summation operation. For example, in an RGB color system, the R, G, and B values for each pixel are summed to provide an RGB sum for each pixel. The RGB components for each pixel may be summed in accordance with equation (1):
Sum=R+G+B (1)

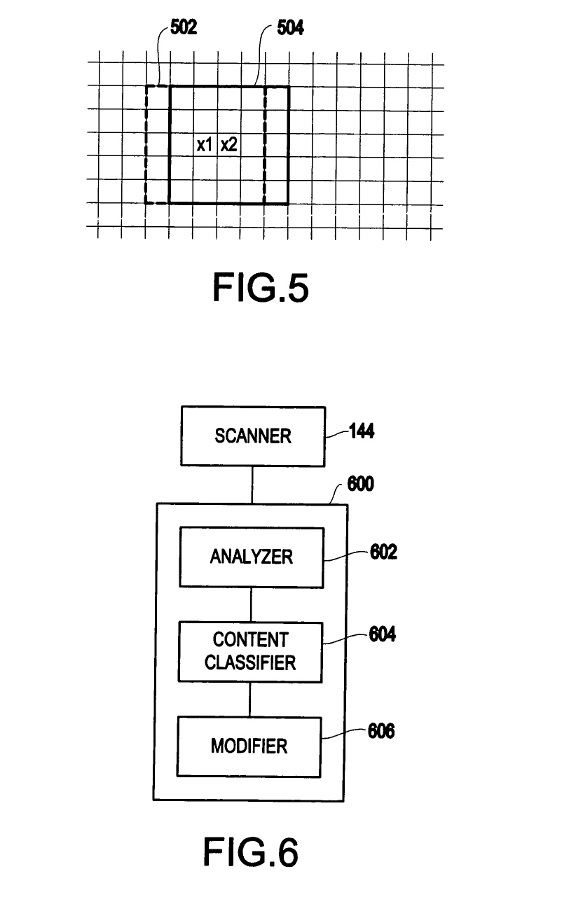

The control routine then continues to step 306 where a pixel in the document is selected for enhancement and the control routine continues to step 310. FIG. 5 illustrates, for example, a pixel X1 that has been selected for processing.

In step 310, the control routine establishes a window, which includes at least one pixel, which is positioned close to the current pixel being processed. For example, FIG. 5 illustrates windows 502 and 504 which each includes pixels that are positioned close to the current pixel being processed. The window 502 corresponds to the current pixel x1 and is a five-by-five pixel window that includes twenty-four (24) pixels that are positioned close to the current pixel X1.

In step 312, the control routine determines the maximum and minimum values of the pixel sums within the window 502 and continues to step 314. In step 314, the control routine determines whether the sum for the current pixel X1 is greater than a first predetermined threshold “wht”.

The value of the first predetermined threshold “wht” may be selected based upon the typical scan values of a pure white scan value for a particular scanner. For example, for pixel values that range from 0 to 255, the first predetermined threshold may be selected such that it falls within a range of about 220 to about 245 based on the characteristic of the scanner.

If, in step 314, the control routine determines that the sum for the current pixel X1 is greater than the first predetermined threshold “wht”, then the control routine has determined that the pixel should have an output value that corresponds to a white value. Thus, the control routine continues to step 316 where the output value for the current pixel X1 is set to a white value. The control routine then continues to step 332, which will be described below.

If, however, in step 314, the control routine determines that the sum for the current pixel X1 does not exceed the first predetermined threshold “wht”, then the control routine continues to step 318.

In step 318, the control routine determines if the sum for the current pixel X1 is less than a second predetermined threshold “blk”.

The value of the second predetermined threshold may be selected based upon the typical scan values of a pure black pixel for the scanner. For example, for pixel values that range from 0 to 255, the second predetermined threshold “blk” may be selected such that it falls within a range of about 10 to about 20 depending on the characteristic of the scanner

If, in step 318, the control routine determines that the sum of component values for the current pixel X1 is less than a second predetermined threshold “blk”, then the control routine continues to step 320 where the output value for the current pixel X1 is assigned a value that corresponds to a black value and continues to step 332. In other words, the control routine determines that the value of the current pixel X1 most likely corresponds to a black pixel.

If, however, in step 318, the control routine determines that the sum for the current pixel X1 is not less than the second predetermined threshold “blk”, then the control routine continues to step 322.

In step 322, the control routine determines whether the difference between the maximum value of a sum for a pixel within the window 502 and the minimum value of a sum for a pixel within the window 502 exceeds a third predetermined threshold “delta1”. This threshold is useful in determining whether to apply text processing or whether image processing may be appropriate.

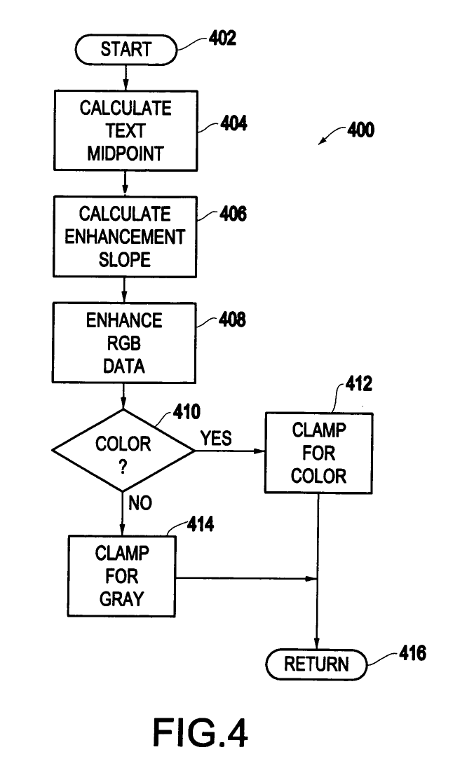

If, in step 322, the control routine determines that the difference between the maximum value of a sum for a pixel within the window 502 and the minimum value of a sum for a pixel within the window 502 exceeds the third predetermined threshold delta1, then the control routine continues to step 324 where the value of the current pixel X1 is processed in accordance with a text and/or line art algorithm which will be described below with reference to FIG. 4 and continues to step 332.

In other words, the control routine determines that the value of the current pixel X1 corresponds to text/line art and applies an enhancement routine that corresponds with that determination.

If, however, in step 322, the control routine determines that the difference between the maximum value of a sum of values for a pixel within the window 502 and the minimum value of a sum of values for a pixel within the window 502 does not exceed the third predetermined threshold “delta1,” then the control routine continues to step 326.

In step 326, the control routine determines whether the difference between the maximum value of a sum for a pixel within the window 502 and the minimum value of a sum for a pixel within the window 502 is less than a fourth predetermined threshold “delta2.” If, in step 326, the control routine determines that the difference between the maximum value of a sum for a pixel within the window 502 and the minimum value of a sum for a pixel within the window 502 is less than the fourth predetermined threshold “delta2,” then the control routine continues to step 328.

In other words, the control routine determines that the current pixel X1 includes content which is most likely an image/picture type of content and applies an enhancement routine that corresponds with that determination.

Given pixel values that may range between 0 and 255, the third predetermined threshold delta1 may range from about 100-150 and the fourth predetermined threshold delta2 may range from about 50-85.

In step 328, the control routine processes the value of the current pixel X1 in accordance with image enhancement algorithms. Image enhancement algorithms are generally known to those of ordinary skill in the art. An exemplary image enhancement algorithm may include, for example, de-screen filtering and gamma correction processes. However, it is to be understood that the present invention may be used with any image enhancement algorithm and still fall within the scope of the appended claims.

After performing the image enhancement step in 328, the control routine then continues to step 332.

If, however, in step 326, the control routine determines that the difference between the maximum value of a sum for a pixel within the window 502 and the minimum value of a sum for a pixel within the window 502 is not less than the fourth predetermined threshold “delta2,” then the control routine continues to step 330.

In step 330, the control routine processes the current pixel X1 in accordance with an enhancement algorithm, which does not necessarily correspond to either of the image and/or text/line art classification of content. In other words, the control routine determines that the current pixel X1 does not appear to correspond to either an image or a text/line art content type. In this instance, it may be most appropriate to merely enhance the contrast of the current pixel X1. For example, the control routine may process the current pixel X1 using a sigmoid function to enhance the contrast.

After processing the current pixel X1 in step 330, the control routine continues to step 332.

In step 332, the control routine determines whether there is another pixel in the document. If, in step 332, the control routine determines that there is another pixel in the document, then the control routine returns to step 308, where the next pixel (for example, pixel X2 in FIG. 4) is selected for processing.

If, however, in step 332, the control routine determines that there is no other pixel to process in the document, then the control routine continues to step 334 where the control routine outputs the process values for the pixels in the document and finishes processing in step 336.

FIG. 4 illustrates a flowchart 400 for a control routine for enhancing and optimizing the value of a pixel that has been classified as text and/or line art content in accordance with step 322 of the flowchart 300 of FIG. 3.

The control routine starts at step 402 and continues to step 404 where the control routine calculates the midpoint of the text within the window 502. The text midpoint is calculated based upon the minimum value of the sum for the pixels in the window 502, the maximum value of the sum of the pixels in the window 502, and a first proportionality constant “texmid” using the following equation:
Mid=Min+texmid*(Max−Min) (2)

The first proportionality constant “texmid” sets the fractional level between the darkest and lightest pixel values in the image window 502 which is taken as the midpoint in determining an outline of the text. The first proportionality constant “texmid” has a range of from 0 to 1. The selection of a value for the first proportionality constant “texmid” controls the white halo versus the black halo of the text. A value for the first proportionality constant “texmid” of 0.5 results in equal halos, a value of 1.0 results in no white halo, and a value of 0 results in no black halo. The first proportionality constant “texmid” also determines the boldness of the text. A higher value provides a more bold text and vice-versa.

The control routine then continues to step 406, where the control routine calculates an enhancement slope, which determines a contrast enhancing slope value “Slope”. The enhancement slope is calculated based upon the minimum value of the sum for the pixels in the window 502, the maximum value of the sum of the pixels in the window 502, and a second proportionality constant “Deltaref” using the following equation:
Slope=(Max−Min)/Deltaref (3)

The control routine then continues to step 408, where the control routine enhances the components of the current pixel X1. Each color component of the current pixel X1 is enhanced in accordance with the minimum value of the sum for the pixels in the window 502, the maximum value of the sum of the pixels in the window 502, the calculated text midpoint “Mid” and the calculated enhancement slope “Slope” in accordance with equations (4) and (5) below:
delR=Slope*(R−Mid) (4)
R′=R+delR (5)

Equations (4) and (5) above are applied to the red “R” component of the current pixel X1 to provide the enhanced R′ value. However, it is understood that all of the components of the current pixel X1 are processed in a similar manner. For example, in an RGB color space, the green “G” and the blue “B” components are also processed using equations (4) and (5) to provide enhanced component values G′ and B′, respectively.

The enhanced R′, G′, and B′ values may exceed a maximum limit within the window 502 and may, therefore, need to be clamped to the maximum limit. The value of the maximum limit may depend on whether the text is color or a gray scale.

The control routine then continues to step 410 where the control routine determines whether the content of the current pixel X1 most likely includes a color type of text/line art or a gray scale type of text/line art. The control routine makes this determination using first parameter “r1” and second parameter “r2” as calculated in accordance with equations (6) and (7) below:
r1=|1−R/G| (6)
r2=|1−B/G (7)

These first and second parameters “r1” and “r2” are then compared with a fifth predetermined threshold “fractgray” to determine whether the content of the current pixel X1 most likely includes a color type of text/line art or a gray scale type of text/line art.

The value assigned to the fifth predetermined threshold “fractgray” determines when the values of “r1” and “r2” determine when the content of the pixel X1 corresponds to a gray text/line art content, rather than a color text/line art. The higher the value of the fifth predetermined threshold “fractgray” the more likely it is that the content will be classified as including gray text/line art content. An appropriate value for the fifth predetermined threshold “fractgray” may be determined experimentally by sampling images, which may typically be processed.

If, both “r1” and “r2” are less than the predetermined threshold “fractgray”, then the control routine determines that the content of the pixel X1 is most likely to include a gray scale type of text/line art and, therefore, continues to step 414.

In step 414, the control routine clamps the enhanced color component values of the current pixel X1 to the maximum and minimum values of each color component for all pixels within the window 502 as modified in accordance with first and second input parameters “enhblk” and “enhwht,” respectively. In particular, each of the color component values of the current pixel X1 is clamped to a minimum value of enhblk*Min and a maximum value of enhwht*Max when the enhanced R═, B═, and G′ values are outside of the range of about enhblk*Min and about enhwht*Max. The control routine then continues to step 416.

If, however, in step 410, the control routine determines that both r1 and r2 are not less than the fifth predetermined threshold “fractgray”, then the control routine determines that the pixel is most likely to include a color type of text/line art and, therefore, continues to step 412.

In step 412, the control routine clamps the enhanced color component values of the current pixel X1 to the maximum and minimum values of each color component for all pixels within the window 502 when enhanced color component values are outside of the Min and Max range. The control routine then continues to step 416.

In step 416, the control routine returns to the control routine of the flowchart of FIG. 3.

While the above exemplary embodiments described a particularly valuable text/line art enhancement algorithm, one of ordinary skill in the art understands that any text/line art enhancement algorithm may be used and still fall within the scope of the appended claims.

Further, while the above exemplary embodiments were described with reference to an RGB color space, those of ordinary skill in the art understand that a document in any color space may be processed and still fall within the scope of the appended claims.

Further, the summation operation in Eq. (1) may be modified to be a weighted sum: Sum=wᵣ*R+w_{g}*G+w_{b}*B, where wᵣ, w_{g} and w_{b} are weighting factors.

FIG. 6 illustrates one exemplary system 600 for performing optimized enhancement upon a document in accordance with the present invention. The system 600 includes an analyzer 602, a content classifier 604, and a modifier 606. The system 600 receives a document from the scanner 144. The analyzer 602 analyzes the characteristics of a first pixel and at least one second pixel positioned near the first pixel in the document. The content classifier classifies the content of the first pixel in accordance with the analysis. The modifier modifies a value of the first pixel based upon the classification. These elements 602, 604, and 606 may generally perform the processes and methods described above.

While the invention has been described in terms of several exemplary embodiments, those skilled in the art will recognize that the invention can be practiced with modification.

Further, it is noted that, Applicants' intent is to encompass equivalents of all claim elements, even if amended later during prosecution.

What is claimed is:

1. A method of processing a document, comprising:
analyzing a characteristic of a first pixel in said document and at least one second pixel positioned near said first pixel;
classifying a content of said first pixel in accordance with said analyzing; and
modifying a value of said first pixel based upon said classifying.

2. The method of claim 1, wherein said analyzing comprises selecting a plurality of second pixels that are positioned near said first pixel, wherein said first pixel and said plurality of second pixels define a window that includes said first pixel, and wherein said window comprises a N pixel by N pixel window.

3. The method of claim 1, further comprising summing color components for each of said first pixel and said at least one second pixel.

4. The method of claim 3, wherein said analyzing comprises determining a maximum and a minimum of sums for each of said first pixel and said at least one second pixel.

5. The method of claim 3, wherein said analyzing comprises determining whether a sum for said first pixel exceeds a predetermined threshold, and wherein said classifying comprises classifying the value of said first pixel as corresponding to a white pixel if said sum for said first pixel exceeds said predetermined threshold.

6. The method of claim 3, wherein said analyzing comprises determining whether a sum for said first pixel is less than a predetermined threshold, and wherein said classifying comprises classifying the value of said first pixel as corresponding to a black pixel if said sum for said first pixel is less than said predetermined threshold.

7. The method of claim 3, wherein said analyzing comprises determining whether a difference between a maximum sum and a minimum sum exceeds a predetermined threshold, and wherein said classifying comprises classifying the value of said first pixel as corresponding to a text/line art content if said difference exceeds said predetermined threshold.

8. The method of claim 7, wherein said modifying comprises:
calculating a text midpoint;
calculating an enhancement slope;
enhancing the value of said first pixel based upon said text midpoint and said enhancement slope;
determining whether the value of said first pixel corresponds to one of a gray scale content and a color content; and
clamping said enhanced value of said first pixel based upon said determining.

9. The method of claim 8, wherein said calculating said text midpoint comprises:
multiplying a difference between said maximum sum and said minimum sum by a proportionality constant; and
adding the product of said multiplying to the minimum sum.

10. The method of claim 8, wherein said calculating said enhancement slope comprises dividing a difference between said maximum sum and said minimum sum by a proportionality constant.

11. The method of claim 8, wherein said determining whether the value of said first pixel corresponds to one of a gray scale content and a color content comprises:
calculating a first parameter based upon the absolute value of a difference between one and a ratio of a first color component relative to a second color component of said first pixel;
calculating a second parameter based upon the absolute value of a difference between one and a ratio of a third color component relative to a second color component of said first pixel; and
determining whether both of said first parameter and said second parameter are less than a predetermined threshold, and
wherein said clamping comprises:
clamping the enhanced value of said first pixel to said maximum and said minimum sum when said first parameter and said second parameter are not both less than said predetermined threshold; and
clamping the enhanced value of said first pixel to the product of a first input parameter (enhwht) and said maximum sum and said the product of a second input parameter (enhblk) and said minimum sum when said first parameter and said second parameter are both less than said fifth predetermined threshold.

12. The method of claim 3, wherein said analyzing comprises determining whether a difference between said maximum sum and said minimum sum is less than a predetermined threshold, and wherein said classifying comprises classifying a value of said first pixel as corresponding to an image content if said difference is less than said predetermined threshold.

13. A system for processing a document, comprising:
an analyzer that analyzes a characteristics of a first pixel and at least one second pixel positioned near said first pixel in said document;
a content classifier that classifies a content of the first pixel in accordance with an output of said analyzer; and
a modifier that modifies a value of the first pixel based upon an output from said content classifier.

14. The system of claim 13, wherein said analyzer selects a plurality of second pixels that are positioned near said first pixel, wherein said first pixel and said plurality of second pixels define a window that includes said first pixel, and wherein said window comprises an N pixel by N pixel window.

15. The system of claim 13, further comprising a summing device that sums the color components for each of said first pixel and said at least one second pixel.

16. The system of claim 15, wherein said analyzer determines a maximum and a minimum of the sums for each of said first pixel and said at least one second pixel.

17. The system of claim 15, wherein said analyzer determines whether a sum for said first pixel exceeds a predetermined threshold, and wherein said classifier classifies the value of said first pixel as corresponding to a white pixel if said sum for said first pixel exceeds said predetermined threshold.

18. The system of claim 15, wherein said analyzer determines whether the sum for said first pixel is less than a predetermined threshold, and wherein said classifier classifies the value of said first pixel as corresponding to a black pixel if said sum for said first pixel is less than said predetermined threshold.

19. The system of claim 16, wherein said analyzer determines whether a difference between said maximum sum and said minimum sum exceeds a predetermined threshold, and wherein said classifier classifies the value of said first pixel as corresponding to a text/line art content if said difference exceeds said predetermined threshold.

20. A signal bearing medium executable by a digital data processing unit for processing a document, comprising:
analyzing a characteristic of a first pixel in the document and at least one second pixel positioned near said first pixel;
classifying a content of said first pixel in accordance with said analyzing; and
modifying a value of said first pixel based upon said classifying.
